(19) United States
(12) Patent Application Publication
(10) Pub. No.: US 2026/0360271 A1
(43) Pub. Date: Nov. 12, 2026

(54) OWNER-AWARE, SCALABLE CUSTOMIZED AND PERSONALIZED COACHING IN DEEP CONTEXTUAL NATURAL CONVERSATIONS

(71) Applicant: SEYED ALI LOGHMANI, San Francisco, CA (US)

(72) Inventor: SEYED ALI LOGHMANI, San Francisco, CA (US)

(21) Appl. No.: 18/099,217

(22) Filed: Jan. 19, 2023

Related U.S. Application Data
(60) Provisional application No. 63/300,979, filed on Jan. 19, 2022.

(51) Int. Cl. G09B 7/02

(52) U.S. Cl. CPC G09B 7/02

(57) ABSTRACT

In one aspect, a computer-implemented method of providing scalable personalized coaching, comprising: receiving, by a computing system, a plurality of subject matter expert (SME) interactions, wherein each SME interaction comprises an SME response portion and an expected student response portion; generating, by the computing system, a plurality of custom learning pathways based on the SME interactions, wherein each custom learning pathway comprises a sequence of interactions leading from an entry point to a terminal mastery point; receiving a student input; determining, by the computing system, a current state based on the student input; identifying an applicable learning pathway from the plurality of custom learning pathways based on the current state; generating a personalized response based on the applicable learning pathway; tracking ownership attribution for content used in the personalized response; and storing the ownership attribution in association with usage metrics of the content.

### DESCRIPTION OF THE RELATED ART

Personalized Coaching, mentoring, and tutoring are not a scalable business models as they are currently practiced. For example, the service provider is physically limited by the number of hours in each day. To scale the business, coaches and tutors turn to group classes cognizant of the adverse effect it produces on the ability to customize and individualize their service.

In the marketplace, there are systems that can generate custom answers to personalized questions. However, such systems generally fail to produce factually correct reactions to multi-step and contextually deep questions. Current systems are designed to generate a response or reaction in deep conversations based on already seen samples in their space model at scale. A big problem with this technique is the fidelity and accuracy of the produced result. Although such techniques, mostly championed by Transformer and other Deep Learning implementations used in products like GPT-3 developed by OpenAI, look coherent and syntactically correct to most, Subject Matter Experts (SMEs) can easily find factually and legally incorrect instances in their generated responses.

In other words, scalable text generation techniques may not reliably produce factually correct and reliable reactions and responses for deep contextual conversations. However, if such systems are fed with enough contextually deep conversations, and factually correct content, in a specific vertical, they could or might produce better results. It is noted that no one can guarantee that a system may always produce factually correct and defensible results in the specific vertical in which they are trained with deep contextual conversations and content.

### BRIEF DESCRIPTION OF THE DRAWINGS

The present application can be best understood by reference to the following description taken in conjunction with the accompanying figures, in which like parts may be referred to by like numerals.

FIG. 1 depicts a flow diagram of an example process of a conversational-search engine, according to some embodiments.

FIG. 2 depicts a flow diagram of another example process of a conversational-search engine, according to some embodiments.

FIG. 3 depicts a flow diagram of yet another example process of a conversational-search engine, according to some embodiments.

FIG. 4 illustrates an example knowledge graph, according to some embodiments.

FIG. 5 illustrates an example conversation graph, according to some embodiments.

FIG. 6 illustrates an example product graph, according to some embodiments.

FIG. 7 is a block diagram of a sample-computing environment that can be utilized to implement some embodiments.

FIG. 8 illustrates an example schematic depiction of a conversation as a sequence of states, according to some embodiments.

FIG. 9 illustrates an example implementation of an NLU system, according to some embodiments.

FIG. 10 illustrates an example schematic diagram illustrating an example target state/decision, according to some embodiments.

FIG. 11 depicts an exemplary computing system that can be configured to perform any one of the processes provided herein.

FIGS. 12 A-B illustrate an example process useful for, with an ensemble of Natural Language Understanding and Processing methods, converting a set of user actions into one or more machine queries over a convoluted data model, according to some embodiments.

FIG. 13 illustrates an example process for augmenting Subject Matter Expert (SME) interactions, according to some embodiments.

FIG. 14 illustrates an example process for implementing a transaction in an SME interaction, according to some embodiments.

FIG. 15 illustrates an example process for custom course/content designing, according to some embodiments.

FIG. 16 illustrates an example process teaching/coaching in two modes, according to some embodiments.

FIG. 17 illustrates an example Subject Matter Expert (SME) interaction system, according to some embodiments.

The Figures described above are a representative set and are not exhaustive with respect to embodying the invention.

### DESCRIPTION

Disclosed are a system, method, and article of manufacture of a convolutional state modeling for planning natural language conversations. Although the present embodiments have been described with reference to specific example embodiments, it can be evident that various modifications and changes may be made to these embodiments without departing from the broader spirit and scope of the particular example embodiment.

References throughout this specification to “one embodiment,” “an embodiment,” or similar language mean that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method.

Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### EXEMPLARY DEFINITIONS

401(k) plan can be a tax-qualified, defined-contribution pension account defined in subsection 401(k) of the Internal Revenue Code.

Action (e.g. a query) refers to an input from the user to the system. Users generate actions. User actions are translated to a tensor or set of variables. This standalone tensor or set of variables is a known state in the space model. This vector or set of variables in addition to the active conversation contexts can be mapped to known states in the space model using a distance calculation technique, or a vector similarity technique, such as an extended form of cosine similarity. The translated action can be a member and a subset of the known space model:

$$Translated Action ∈ Space ModelTranslated Action = \{ {var}_{α} , {var}_{β} , … . \} = {S}_{γ} Context = {\sum }_{i = first observed state}^{last occured state} {■ S}_{i}$$

Canonicalization can be a process for converting data that has more than one possible representation into a standard, normal, or canonical form.

Decision/Target state/Response can refer to an output rendered by the system in return to an input action. Decisions are produced by multiple components. Decisions are made by the system. A decision can be referred to a set of variables/tensors with particular values that are a result of applying a user generated input to a certain state in the system. This results in a new state that is called a target state or decision. A decision can manifest itself to a user in the form of text, video, image, sound, or a combination of such content types on different devices. The rendered decision can be looked up using retrieval techniques or generalized/synthesized using generative methods.

Convolutional operations can include, inter alia: set addition, subtraction, intersection, quality, and other functions that can be overloaded in a convolutional model. They operate as exact match on tensors and parameters, as well as cosine similarity in n dimensional space. For example, two tensors are convolutionally equal if they are an exact match or if they have a cosine similarity that is close to one. The threshold can be trained and learned based on available tensors and data. The same can also be applicable to convoluted intersections. Two sets intersect if they have exact matches or if there are tensors with near one cosine similarity. The operations can be provided herein are convolutional unless explicitly stated otherwise. In some equations there is a superscript asterisk (*) to emphasize the convolutional overloading. If the asterisk is not explicitly given, still such an operation is considered as convolutional unless explicitly stated otherwise.

State is now discussed. A certain set of variables with particular values/vectors that can be re-produced by applying certain inputs/actions to a previous set of variables with particular values is called a state. A state can have two consumers: a computer system and a human. To the computer system, a state can be represented by a tensor or a set of variables (e.g. such variables can be represented by tensors depending on the inherent machine learning methods used).

S=[0.34 . . . 0.15 [symbol] 0.56 . . . 0.21]∨S={variableₒ, . . . ,variableₙ} Equation 1—State is a tensor or set of one-to-many variables

To humans a state can be represented by one-to-many knowledge nodes. A knowledge node is a human representable text, video, image, or document.

Basic State/Node can include, inter alia: a basic or atomic state that is not broken down into sub states because it simply does not make sense, or its further dissection does not justify the investment depending on the restrictions or preferences of the use case or domain. For example, in a use case “401k” can be considered as a basic state, but in another use case, one might want to break it into two more sub states like “pension plan”, “retirement savings”. Atomic/basic states can have dependencies, knowledge assets and relationships to other states. A basic or atomic state does not have any sub-states, but it can become part of many hyper states.

∀S⊂S_{atomic}⇒S=S_{atomic}∨S=∅ Equation 2—Atomic States have no sub-states

Hyper-state/node or convolutional state can be when two or more states are combined, and a hyper or convolutional state is created. For example, “401k projections” is a hyper state. Hyper states inherit the dependencies and knowledge assets of the sub states.

S_{α}+*S_{β}=*S_{γ}S_{γ}−*S_{α}=*S_{β} Equation 3—States can be added and subtracted

∀S_{hyper}:∃S_{α},S_{β} so that (S_{α}∩*S_{β}=∅)∧(S_{α}⊂S_{hyper}∧S_{β}⊂S_{hyper}) Equation 4—Hyper states are composed by two or more states

if S_{α}⊂S_{β}∧dependencyᵢ∈Sₐ⇒dependencyᵢ∈S_{β} Equation 5—Hyper states inherit all variables and dependencies of the sub states

Variable is an atomic piece of information/intelligence provided by the user and collected or recognized by the system.

Dependency is an atomic variable which is acquired and observed so the state or states which encapsulate this variable can become relevant to the context of the conversation. A dependency is a state variable that informs the system to proactively collect a value from the user.

Distance between two states can be measured by a number of different variables between the two. This difference can be fulfilled by one or a plurality of combinations of other states. For example, in a conversation the distance between a greeting state and a product purchase state can be bridged by a plurality of different paths, each path can be a composition of a variety of states.

distance(S_{α},S_{β})=Δ(S_{α},S_{β})=*S_{α}−*S_{β}∈*{(S_{θ}+*S_{ϑ}+*S_{λ}),(S_{γ}+*S_{ε}), . . . } Equation 6—Distance of two states can be measured by number of states which can cover the delta of variables

Non-fungible token (NFT) is a unique and non-interchangeable unit of data stored on a digital ledger (blockchain). NFTs can be associated with reproducible digital files such as photos, videos, and audio. NFTs use a digital ledger to provide a public certificate of authenticity or proof of ownership, but it does not restrict the sharing or copying of the underlying digital file.

Space Model (e.g. a conversation planning space model) can be a collection of discrete states modeled by inherent variables and dependencies. The space model can contain multiple entry states or zero states and a plurality of terminal or offer states.

$$Active conversation = \{ {S}_{α} , {S}_{β} , … \} ( without a terminal state ) Active conversation ⊆ ContextSpace Model = All known states in the system {\sum }_{■}^{■} ■active conversations ⊆ Context ⊆ Space Model$$

$$Equation for Space model definition$$

Subject-matter expert (SME) is a person who is an authority in a particular area or topic.

Offer state can be a terminal or destination state. For example, reaching a checkout state in an ecommerce conversation can be deemed as a terminal state.

Conversation context is a collection of previous states and their inherent variables from state zero to now. It can be represented as a set of variables/tensors with particular values aggregated, acquired, inferred, and deduced from the beginning of a conversation with a user.

Conversation Planning can be a function of guiding a conversation from a starting state to a terminal state. Conversation planning is a stochastic, multi-agent, sequential, discrete, partially observable, and dynamic process. The process can, at times, be episodic when the system has the answer to questions which do not change the current state of the conversation. The planning function can be done via a plurality of techniques, such as, inter alia: extended variations of Partially Observable Markov Decision Process, extended forms of Bayesian Inferencing, A* planning or a hybrid of such methods, etc. An aspect of planning can include finding a most probable terminal state based on the partially observed states. To find the highest probable state given the context of the conversation of observed dependencies, a plurality of techniques can be used including but not limited to extended variations of Partially Observable Markov Decision Process, or extended forms of Bayesian Inferencing, A* planning or a hybrid of such methods.

For example, if a consumer looks up information about blurry vision, and later the same user looks up information about itchy skin, the observed “blurry vision” and “itchy skin” dependencies can produce a substantial probability to attribute these symptoms to diabetes. This attribution can be done by different planning methods. Also, to verify this inference, the planning process can strategize or plan a path to ask/acquire/observe more dependencies to reject or verify the accuracy of this inferencing. The information collection path is another aspect of planning. In case of both rejection and approval, the system can passively learn from its observations.

Translated Action+*Active Conversationᵢ∈Space ModelWinner State=(dist(Tranislated Action+*Active Conversationᵢ,Space Model)) Equation 8—Conversation Planning and searching the winner state using distance

Winner State=((Translated Action+*Active Conversationᵢ)∩*Space Model Equation 9—Conversation Planning and searching the winner state using the greatest number of common sub states

Knowledge Model can be a model that represents knowledge in the form of states in a Vector Space Model represented by tensors or a set of vectors or variables. In other words, the knowledge model is a domain specific space model containing the possible states to which the system is supposed to react and respond within that particular domain in which the system is implemented. The possible states that the system knows, can predict (and/or can react to) are encoded, stored in the knowledge model. Inferred States (e.g. decisions, etc.) can be represented differently, on different devices during content delivery, but the inherent inferred state (e.g. a decision, etc.) remains the same. The knowledge graph describes the flow of conversations between states within the knowledge model. A knowledge model is a collection of possible states the system knows and can react to.

Natural language understanding (NLU) is a subtopic of natural language processing in artificial intelligence that deals with machine-reading comprehension. The NLU component is responsible for mapping user inputs to patterns that the system understands and can react to. The NLU component can use different techniques to implement this (e.g. extracting entities from user inputs, chunking, and classifying smaller pieces, determining sentiments, translating, summarizing, canonicalizing sentences, etc.) in order to map user inputs to states in the knowledge model.

Dialog manager can track active and unfinished conversations of each user spanning in current and the previous sessions.

Conversation graph can be a log of actual interactions between the users, the system, and the resulting states. A conversation can be a sequence of states. A conversation between one user and the system can be a sub graph in the larger conversations graph. The user generated actions (and its generalized version), and the system made decision can be stored in the conversation graph as nodes. An action generalization can reduce entropy in the graph, as well as also increase likelihood of multiple conversations sharing nodes.
Contextual System Query can be a tensor or a set of vectors or a set of variables used to query the knowledge model in the vector space model. The query is built by adding the context vector or set of variables to the latest processed user input action. The built query tensor or set of variables is then queried over the knowledge model in order to find the closest state.

Response State=((Translated Action+*Current Context)∩*Space Model) Equation 10—Querying the knowledge model using the contextual system query

Convoluted knowledge model can store a set of system states. The states can be atomic or hybrid. The states are represented by tensors or a set of variables in a vector space model. It is noted that building complex states using other atomic or convoluted states allows the system to model various possible permutations and combinations of sub-states and their permutations. The convolutional state model enables the system to match a permutation set of states with a hybrid state in the knowledge model in case there is significance in the sequence of states. For example, in the pizza ordering domain, the state of adding extra cheese and the state of thin crust can be shuffled and all permutations can be mapped to one single hyper state in the knowledge model. The convoluted knowledge model can also store sequence-based states where sequence of the sub-states matter. In other words, in case sequence of user generated action matters there can be corresponding sequence-based states in the knowledge model. This design has better scalability compared to decision trees, decision support system, dialog-based conversations, and knowledge graphs. This design does not produce branches in a tree-like structure. Instead, it produces a set of sets that can include one another. These sets can be mapped to graphs for nearest search and planning purposes.

Dynamic Memory Network (DMN) can be a neural network architecture which processes input sequences and questions, forms episodic memories, and generates relevant answers. Questions can trigger an iterative attention process which allows the model to condition its attention on the inputs and the result of previous iterations. These results are then reasoned over in a hierarchical recurrent sequence model to generate answers. The DMN can be trained end-to-end and obtain results on several types of tasks and datasets.

Knowledge graphs (e.g. an ontology) can formalize naming and definition of the types, properties, and interrelationships of the entities that really or fundamentally exist for a particular domain of discourse. The convolutional state model can be represented in the form of a graph as well. This conversion is useful for distance calculation.

Generative adversarial networks (GAN) are a branch of unsupervised machine learning, implemented by a system of two neural networks competing against each other in a zero-sum game framework.

Individual retirement account (IRA) is a form of individual retirement plan provided by many financial institutions, that provides tax advantages for retirement savings in the United States. An IRA can be described in IRS Publication 590.

Named-entity recognition (NER) is a sub-task of information extraction that seeks to locate and classify named entities in text into predefined categories such as the names of persons, organizations, locations, expressions of times, quantities, monetary values, percentages, etc.

Neural networks are a computational approach, which is based on a large collection of neural units (e.g. artificial neurons), loosely modeling the way a biological brain solves problems with large clusters of biological neurons connected by axons. Each neural unit can be connected with neural units, and links can be enforcing or inhibitory in their effect on the activation state of connected neural units. Each individual neural unit may have a summation function which combines the values of its inputs together. There can be a threshold function and/or limiting function on each connection and on the unit itself (such that the signal surpasses the limit before propagating to other neurons). These systems can be self-learning and trained, rather than explicitly programmed, and excel in areas where the solution or feature detection is difficult to express in a traditional computer program.

Perplexity can be a measurement of how well a probability distribution or probability model predicts a sample. It can be used to compare probability models. A low perplexity indicates the probability distribution is good at predicting the sample.

Product graphs can contain products of interest in a specified domain (e.g. financial services, retail, fitness) and their corresponding attributes. Each product in this graph can be specified by a sub graph of nodes. Each node can be a product attribute, feature, or specification.

Roth IRA (Individual Retirement Arrangement) is a retirement plan under US law that is generally not taxed, provided certain conditions are met.

Sentiment analysis can refer to the use of natural language processing, text analysis, computational linguistics, and biometrics to systematically identify, extract, quantify, and study affective states and subjective information.

Subject-matter expert (SME) can be a person who is an authority in a particular area or topic. An SME can have special knowledge or skills in a particular area of endeavor.

Vector space model (VSM) is an algebraic model for representing objects (e.g. conversations, text documents, etc.) as vectors of identifiers, such as, for example, index terms. A VSM can be used in information filtering, information retrieval, indexing and relevancy rankings.

Word embedding can be a set of language modeling and feature learning techniques in natural language processing (NLP) where words and/or phrases from a vocabulary are mapped to vectors of real numbers. Word embedding can include mathematical embedding from a space with one dimension-per-word to a continuous vector space with much lower dimension. Methods to generate this mapping can include neural networks, dimensionality reduction on the word co-occurrence matrix, probabilistic models, and explicit representation in terms of the context in which words appear.

Convolutional Neural Network (CNN) is comprised of one or more convolutional layers (often with a subsampling step) and then followed by one or more fully connected layers as in a standard multilayer neural network. The architecture of a CNN is designed to take advantage of the 2D structure of an input image (or other 2D input such as a speech signal)

Long short-term memory (LSTM) units (or blocks) are a building unit for layers of a recurrent neural network (RNN). An RNN composed of LSTM units is often called an LSTM network. A common LSTM unit is composed of a cell, an input gate, an output gate and a forget gate. The cell is responsible for “remembering” values over arbitrary time intervals; hence the word “memory” in LSTM. Each of the three gates can be thought of as a “conventional” artificial neuron, as in a multi-layer (or feedforward) neural network: that is, they compute an activation (using an activation function) of a weighted sum. Intuitively, they can be thought as regulators of the flow of values that goes through the connections of the LSTM; hence the denotation “gate”. There are connections between these gates and the cell.

Seq2Seq: The encoder-decoder architecture for recurrent neural networks is the standard neural machine translation method that rivals and, in some cases, outperforms classical statistical machine translation methods.

### Exemplary Processes

Example embodiments of a conversational-search engine are provided. In one example, a conversational-search engine can be implemented in specified domains (e.g. parenting, health care, financial domain, education domain, travel-planning domain, etc.). For example, a user can provide a series of financial-related actions/queries to the conversational-search engine. The conversational-search engine can pre-process said actions/queries (e.g. canonicalize, generalize, summarize, etc.). The system implanting the conversational-search engine can generate and/or maintain a set of graphs embedded within a knowledge model. Each graph shows a logical path between states and nodes in the knowledge model. This set of graphs can include a conversation graph, a knowledge graph, a product graph, etc. This set of graphs can be used to generate a response to the user's action/query. The response to the user's action/query can be converted to a colloquial state for presentation to the user.

The conversational-search engine can generate and ask follow-up questions to the user. For example, the conversational-search engine can review a user's recent search history to plan a future decision/response for the user. A future decision/response can be a product or service that is offered to the user. For example, the future decision/response can be a specified financial offering to the user (e.g. a 401K product, an IRA product, a student-loan repayment strategy, specific financial advice, etc.).

When a conversation is initiated, the conversational-search engine can, based on the context of the conversation, calculate a distance (e.g. as represented by a graph of various action/response node) before it can render the new state which can include an offer or product/service to the user. Distance can be a function of how many product parameters/attributes are to be determined until the goal state is offered to the user.

The state model graph is heuristically admissible. For example, take 401k calculations as a product, to calculate projection of 401k distribution ten (10) years after retirement, the product graph can have some dependencies/variables (e.g. current 401k savings, retirement age, etc.) which are to be acquired/fulfilled before the system can calculate the 401k projection. As an example, if the system has to fulfill N dependencies or parameters before a calculation can be done, before a product can be searched, or before a request can be invoked, then the distance between current state to the fulfillment state is N hops. For example, N (the number of parameters to be acquired) is the number of hops between the generated action by the user and a terminal state in the knowledge model. Based on the context of the conversation and the domain-level variables already acquired for the current user (e.g. historically and during the current session), the system can calculate the distance of the current state of the conversation to all possible products in the product graph. Once the distance is calculated, a strategy (e.g. a sequence of questions) is planned to proactively guide the conversation towards the nearest product.

A contextual-system query-scoring model is now discussed. The scoring model can be based on cosine similarity and soft cosine similarity distance between the contextual system query and knowledge model states. The best match can be the greatest number returned by the before mentioned methods using the two tensors or two sets of variables.

$$Scoring model using Cosine Similarity and Soft Cosine Similarity Between Contextual System Query and Knowledge Model ( i . e . a Space Model ) states \qquad Equation 11$$

$$Score = \frac{{\sum }_{i = 1}^{n} {■ ( Contextual System Query )}_{i} {( Knowledge Model State )}_{i}}{\sqrt{{\sum }_{i = 1}^{n} {■ ( Contextual System Query )}_{i}^{2} \sqrt{{\sum }_{i = 0}^{n} {■ ( Knowledge Model State )}_{i}^{2}}}}$$

A decision-tie breaker can be used to return one winning decision from multiple qualified decisions with the same initial scores. Decision-tie breakers can utilize multiple techniques in serial or in parallel. The first method is by increasing precision of the cosine similarity and soft cosine similarity distance explained in the scoring model. If there are still multiple states producing identical distances or scores in the vector-space model, then the subsequent tie breaker techniques can kick in. It is noted that in occurrence of such cases, the attention model can also be used to ensure that less important tensors or variables are given lower scores and more important ones are given more weights.

The next tie breaker mechanism is based on the least number of unfilled sub-states for the qualified states. If there are multiple winning states with the same number of common sub states, the one which is closest to a terminal, or has the least number of unfulfilled states is the eventual winner.

In addition to this technique, the following techniques can be used in conjunction with the least number of unsatisfied sub-state methods. The backup techniques can include an attention model. The attention model gives weight to certain previous states in the conversation. The attention model is a vector which multiplies less important states with close to zero numbers and more important states with numbers closer to one. This vector can be learned using machine learning techniques. Also, the attention model vector can have preset values. Another technique used for breaking ties is temporality of variables and sub states acquired. For example, certain observations or acquired dependencies might be good to answer an episodic or stateless question, and therefore, their lifetime will not last more than a span of a question and answer. On the other hand, there are observations and induced states that would last much longer. The eternal observations will not die out, but ephemeral observations are good only for one query.

$$Tie breaking formula using convolutional intersection \qquad Equation 12$$

$$if count ( win state ) > 1 \text{=>} win state = tie breaker ( win states ) distance = {\sum }_{i = last state}^{first state} ■ ( attention vector * {S}_{i} ) tie break winner = ( distance ∧ count of unfulfilled substates ) for all win states$$

A conversational-search engine can implement responses using various deep-learning methodologies, or by looking up pre-curated content. For example, conversational-search engines can utilize a plurality of artificial intelligence and machine learning algorithms to implement responses. Once the system determines the new state of the system after a user action is processed, the system can map the new state to a pre-curated content (information retrieval methods) or use machine learning techniques to decode the new state to text, video, image, or a combination of all (e.g. with generative methods).

In some example embodiments, conversational-search engine can use various types of graphs or models, including, inter alia: a knowledge model, conversation graph, a knowledge graph and/or a product graph. A conversation model is a collection of the possible states the system knows and can react to. A conversation graph can be log of a conversation previously seen by the conversational-search engine. The conversation graph can include actual and generalized actions and generated decisions by the conversational-search engine.

During the span of each conversation, the product graph is used to determine which products are relevant to the context of the conversation and what the future decisions are to appear as. Also, the product graph can explain how a product can be qualified to be offered. In other words, a product graph which is a subset of the knowledge model, defines the dependencies which have to be observed before the terminal/offer state for the product can be fulfilled/reached. The product graph can be used to build a strategy as to how to acquire all necessary attributes and dependencies from the user, so a product can be offered to the user. Knowledge graphs can include the entities in the specified domain and their relationship to each other. Knowledge graph is also a subset of the knowledge model. Knowledge model and its states can be represented into a graph, which is called a knowledge graph. This conversation can be used to perform conventional graph functions, like shortest path, etc. Relationships can be defined based on, inter alia: similarity, difference, compatibility, usability, etc. For example, in the financial services domain, the “401k” entity node is connected to the “IRA” node through multiple edges, one edge can be similar, the other edge be different, another edge can be fund-transfer. Another example in the fitness domain can be the relationship of the “weighted pushup” entity to “bench press” entity. The similarity can be inferred based on the underlying sub states that the hyper states inherit. There can be an edge connecting these entities explaining how these two entities are similar. A next edge can explain how these two are different. Another edge can explain how these two can be combined in a workout cycle. Again, the difference can be derived by comparing the sub-states which are exclusively inherited by each of these hyper states.

Another example in the food vertical can be relationships between “Chicken Schnitzel” and “Chicken Ravioli”. The knowledge graph can be pre-curated. In the domain specific knowledge model, there are two sets of entities: basic entities/states and hyper entities/states. Hyper states/entities are entities which encompass two or more entities, basic or hyper. For example, in the diet vertical the node “diet” is a basic entity, the node “low carb” is also a basic entity. The node “diet” has its own knowledge or information data, and sample media assets associated with it. For example, if a user asked, “what is diet?”, the system can fetch the sample information/knowledge associated with the node “diet” from the system as the response. The node “low carb” also has associated knowledge, media assets (like sample images, videos, etc.) associated with it. The hyper node “Low Carb Diet” is a new node/state composed of the two basic nodes/states “diet” and “low carb”. This hyper node inherits the content, knowledge, and media assets of the enclosing assets, in addition to its own unique assets and knowledge/information content. For example, to answer “what is low carb diet” the system can fetch the knowledge associated directly to the hyper node. Each knowledge model node contains the following items:
a list of sub entities (e.g. a basic node has no sub entities, and a hyper node has at least two or more sub entities); and
a list of direct dependencies (e.g. a dependency is a piece of data which has to be collected from the user or inferred by invoking an API before the system can return the knowledge item associated to this state/node). Hyper-states/nodes can inherit sub dependencies. Accordingly, in order to get to the knowledge item of a hyper node, the immediate dependencies associated to the hyper node as well as the dependencies associated to the sub entities must be acquired and fulfilled. For example, to calculate 401k distribution projection five (5) years after retirement, all the dependencies inherited from the sub entities and the immediate dependencies of the hyper node “401 distribution calculator” are to be fulfilled and acquired. Sample dependencies can be “age”, “base salary” and “annual raise percentage”, etc. To acquire and fulfill dependencies the system can strategize and generate a series of questions. It is noted that the list of dependencies is also referred to as a product graph.

The list of media assets can be an optional list. A media asset can be a picture, a video, or an audio file. The media asset list is used to represent additional information about a node. The list of assets can be displayed when the dependencies of the node are fulfilled.

The list of knowledge items is now discussed. A knowledge item is a generalized piece of text. Knowledge items may not be served to the user until all the dependencies of the node are acquired. The system can show one or a plurality of the knowledge items associated with a state/node. The system can choose to contextualize the general knowledge items associated with nodes during runtime. The base knowledge item can be further generalized while delivery, to show a more personalized text, or even generate/select an image, a video, or a combination thereof.

The named-entity recognition (NER) is a subtask of information extraction that seeks to locate and classify named entities in text into predefined categories such as, inter alia: the names of persons, organizations, locations, expressions of times, quantities, monetary values, percentages, etc.

Classification can be used to categorize a sentence or user action. A user action can be categorized to one or multiple classes or categories. For example, “Hello” can be categorized as “Greeting” and “yes” can be categorized as “Affirmation”. The classes obtained can be used as additional data to better assist mapping user actions to states within the knowledge model and produce a more reliable and transparent mapping. Another example can be, “After using the lotion my itching got worse” can be categorized as “condition deteriorated” and “used prescription”. To determine classes of user actions different architectures and ML techniques can be used.

Sentiment analysis can be used to determine sentiment of a user action. For example, “My interest rate is high” in the financial services domain has a negative sentiment. Another example “Very rarely” can produce a negative sentiment depending on existing context in response to which user has produced such action. The sentiment of each user action produces useful data points which can be used as additional data to better assist mapping user actions to states within the knowledge model and produce a more reliable and transparent mapping. Different various machine learning (ML) techniques and architectures can be used for sentiment analysis of user actions.

A standalone system query can be a translated query using provided data by the user without using contextual data. It can be assumed that the system is stateless and then the user query is translated into a system query. This standalone system query can produce a qualified state in the knowledge model. This score can be compared with the result of a contextual system query and then the winner can be chosen. This mechanism helps the system whether the latest user action is following the existing context or conversations or is starting a new one or is a stateless action.

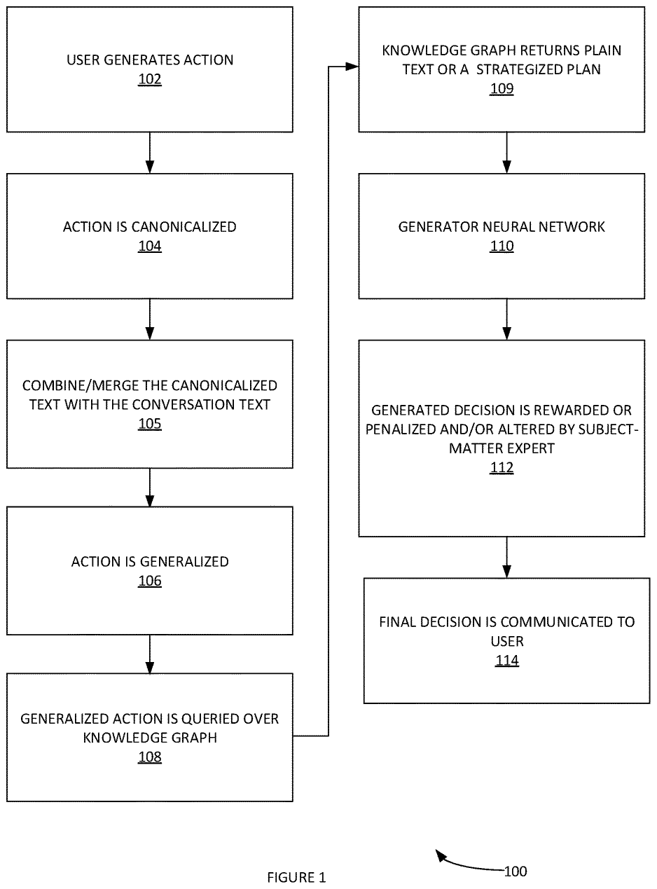

FIG. 1 depicts a flow diagram of an example process 100 of a conversational-search engine, according to some embodiments. In step 102 of process 100, a user generates an action. An action can be a user query and/or other request for information about a product or service. In step 104 of process 100, action is canonicalized. For example, the user query can be modified into a standardized/canonical form. For example, user action can be “Kan I conbute to mltpl 401s”. The canonicalized version can be “Can I contribute to multiple 401(k) accounts?”.

In step 105, the canonicalized action is combined with the conversation context (e.g. previous states). In case the new action is a follow up question, this step generates a more detailed question. For example, a user had asked about 401(k) previously and the canonicalized action is “What is the max”. This step can produce a new canonicalized action like “What is the maximum 401(k) annual contribution”.

In step 106, the action can be generalized. Generalization can include the summarization of different sentences to shorter versions. In one example of generalization/summarization the user action can be “Please compare 401k with Roth IRA”, or “401k vs Roth IRA”. Step 106 can convert this to a summarized/generalized form of “Find similarities between 401k and Roth IRA”. In another example, the user action can be “my college loan interest rate is awful, what should I do?”. Step 106 can translate this to a summarized/generalized form of “Find remedies to reduce college loan interest rate”. Very long actions can be broken down into smaller pieces/chunks and then re-combined to form the original query. Each generalized chunk can map to a particular sub-state in the knowledge model. The new decision can be a hyper state encompassing such sub-states. For example, in the finance vertical, if user's action is “I am planning to go back home to UK, I have been working in the us on an HIB visa, can I rollover my 401k savings to a pension plan in the UK”, can be broken down to “I am planning to go back home to UK”, “I have been working in the us on an H1B visa”, “can I rollover my 401k to a savings plan in the UK”. With respect to the financial services domain, some of the provided information can be discarded. Necessary information can be extracted using NER techniques. Each chunk represents a new state in the knowledge model. The broken-down statements can be further generalized and translated to a query for knowledge model like this “find 401k to UK-pension rollover”.

An ensemble of different AI techniques can be used to perform the translation from natural query to knowledge model query. For example, a set of CNN, LSTM, or Seq2Seq techniques can be used to perform NER, and natural query to system query translation. The translated system query can be sent to the knowledge model to fetch a proper response.

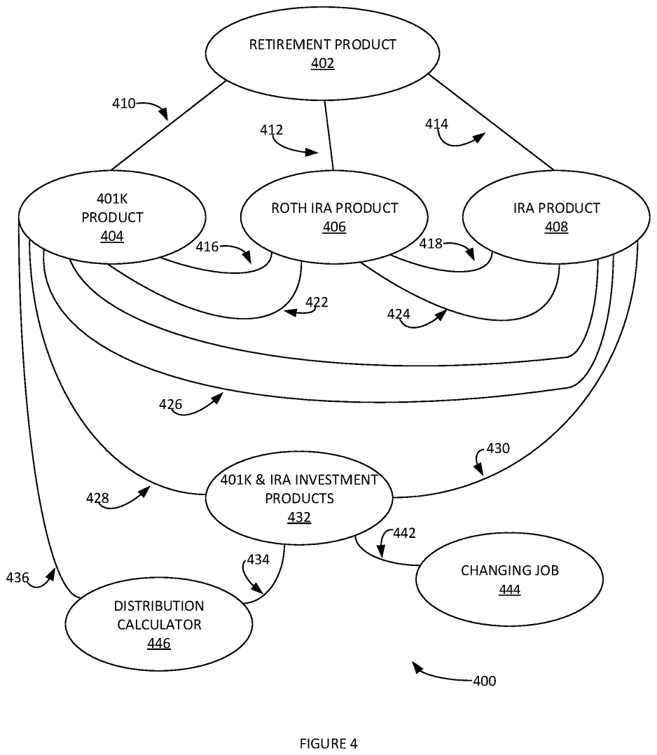

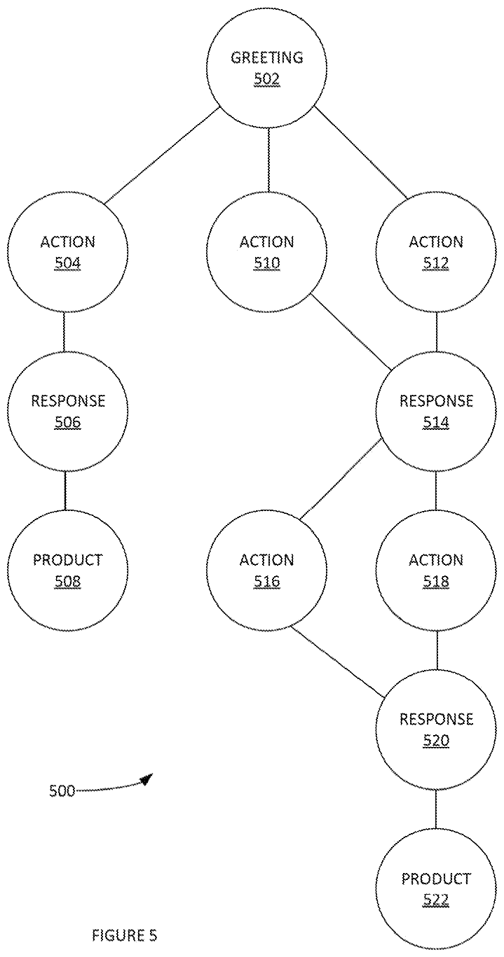

In step 108, the generalized action form of the user's action is queried over a knowledge model. An example knowledge model is provided infra in the description of FIG. 4. The translated system query can find the nearest node/state (e.g. a hyper node or a basic node). The system query can have zero to many variables in it. These variables can be matched with the states/nodes in the knowledge model. In addition to the query variables, existing fulfilled dependencies/variables in the context of the conversation can be used in the process of finding the best state/node match. For example, if the translated query looks like “calculate BMI age 34”, and if the context object holds a key value pair for weight (e.g. weight 168 lbs.), then the system can search/plan for a node/state that has the greatest number of matches to “calculate BMI”, with “age” and “weight” dependencies fulfilled and the least number of unfulfilled dependencies. Also, this planning process can use extended variations of Partially Observable Markov Decision Process, or extended forms of Bayesian Inferencing, or a hybrid of such methods to find the most probable state available in the space model. In cases where more than one node/state is returned different tie-breaker policies can be used.

Two example tie-breaker methods are attention-tie-breaker and temporal-tie-breaker. An attention-tie-breaker gives more weight to certain dependencies learned from previous training. The dependencies with more weights qualify as the winner. The attention-tie-breaker weight vector can be learned through an ensemble of different AI techniques including, but not limited to, LSTM, and Seq2Seq. The temporal-tie-breaker gives more weight to more recent dependencies. An acquired dependency is tagged with a timestamp.

In step 109, the knowledge model can return plain text or a strategic plan. The strategize plan is produced from the list of aggregate unfulfilled dependencies associated immediately to a hyper or basic state (in case the node is a hyper state, in addition to immediate dependencies, list of inherited dependencies from the internal entities embedded in that hyper states are also added to the strategized plan).

In step 110, the output decision of step 109 is fed to a generator neural network. The generator neural network can contextualize the text generated by the previous step. For example, this text “Important downside, under 50, max contribution is $17,000” can be contextualized as “An important downside is, since you are 34 and under 50, that you cannot contribute more than $17,000 a year to your 401(k) plan”. Step 110 can render a colloquial and a more personalized text for users. Various personalization effects can be included into the output of step 110. The contextualization process can be done by using machine learning and artificial intelligence techniques including but not limited to LSTM, sequence 2 sequence and GAN.

In step 112, a generated decision can be rewarded or penalized and/or altered by a subject-matter expert. Rewards, penalties, and changes are fed back to the system for further learning through reinforcement learning components. In step 114, a final decision is communicated to the user.

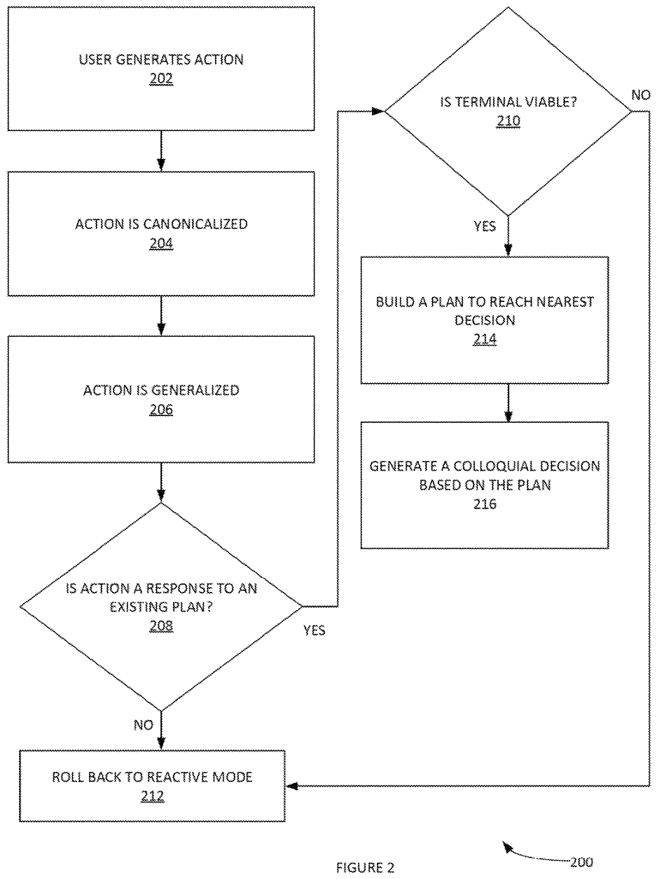

FIG. 2 depicts a flow diagram of another example process 200 of a conversational-search engine, according to some embodiments. In step 202, a user generates an action. In step 204, an action can be canonicalized. In the step, the canonicalized action is combined with the conversation context and previous states. This step helps to combine the pattern recognition task of the user input with the current state of the conversation to better map the system to a target state. For example, if a user had previously asked “Do I need to pay extra tax if I take a loan from my 401(k) accounts”, and subsequently asks “What if I am 61”.

The combined state is pushed to step 206, where the latest aggregated state is generalized. The previous sequence can be generalized to “Find if should pay extra tax for 401(k) loan when age is more than 59.5”. In step 208, it can be determined whether the action is a response to an existing plan. For example, in the fitness and food vertical if the user action is “I want to lose 40 lbs. for my wedding”, the system maps this input to a state which can predict the user is asking for a weight loss product/program. Therefore, using the product graph (which is created from the list of outstanding dependencies associated with that node), the system can strategize a series of steps to guide the conversation to a weight loss program. The system can review the conversation context and user's history to collect and fulfill the variables required for a weight loss program, if possible. The remaining variables, if any, can be collected through a series of questions strategized in this step of the algorithm. In this state the system can proactively guide the conversation to eventually suggest a product or offering. The system can ask one question at a time. If the user action is in response to the asked question/decision (generated by the system) the system stays in proactive mode. In proactive mode the next step is 210. If ‘no’, then step 208 can roll back to reactive mode in step 212 for this interaction. However, the system can still ask if the user is still interested to continue the conversation for the offering/product which is still fresh in the context of the conversation. If the user's action is in response to an existing plan, it can be determined whether the terminal node is viable in step 210. If ‘no’, then process 200 can proceed to step 212. In step 214, process 200 can build a plan to reach the nearest decision.

In step 216, process 200 can generate a colloquial decision based on the plan strategy. The raw output can be contextualized by following the algorithm specified in process 100 (of FIG. 1), step 110 onward. In proactive mode the system can generate a decision to user, stating that it acknowledges that it had received an action/response relevant to its decision/question, and can immediately ask the next question in the strategized sequence. A strategized sequence can be a sequence of questions planned to guide the current state of the conversation to a terminal/product/offering in the product graph. For example, in order to offer 401(k) calculator, a few questions can be asked before the system can show distribution projections (e.g. current age, current 401k balance, salary, etc.). Another example can be about weight loss, a strategized sequence of questions before a product can be offered can contain questions about current weight, age, gender, etc. If a user's action is not in response to a question of a strategic plan, as explained previously, the system temporarily rolls back to reactive mode to (following process 100), to respond to user's question with proper colloquial decision/answer. Immediately after that the system can fall back to the proactive mode again to ask the unsatisfied question again.

For example, for weight loss the system asks, “What are your favorite snacks?”. If a user responds with “How many calories are there in a Snickers bar?”, the system can rollback to reactive mode since user action is not in response to its question/decision. The system can answer “215 calories”. Then the system can immediately return to proactive mode and it can ask the unsatisfied question/decision again. The question can be personalized and re-contextualized to look more natural and friendlier. For example, it can ask “Ok, let me ask again, do you have any favorite snacks?”, or alternatively it can ask “Besides chocolate, what other snacks do you like?”. The component which tracks active conversations for one user in one or all sessions is called the dialog manager. The dialog manager uses an existing sequence of conversation states (e.g. a conversation context), existing conversations and potential terminal states, and compares these with the latest generated query to determine which conversation has to be continued. The winning conversation is a winning state. To determine the winning state a tie-breaking step can be utilized as well.

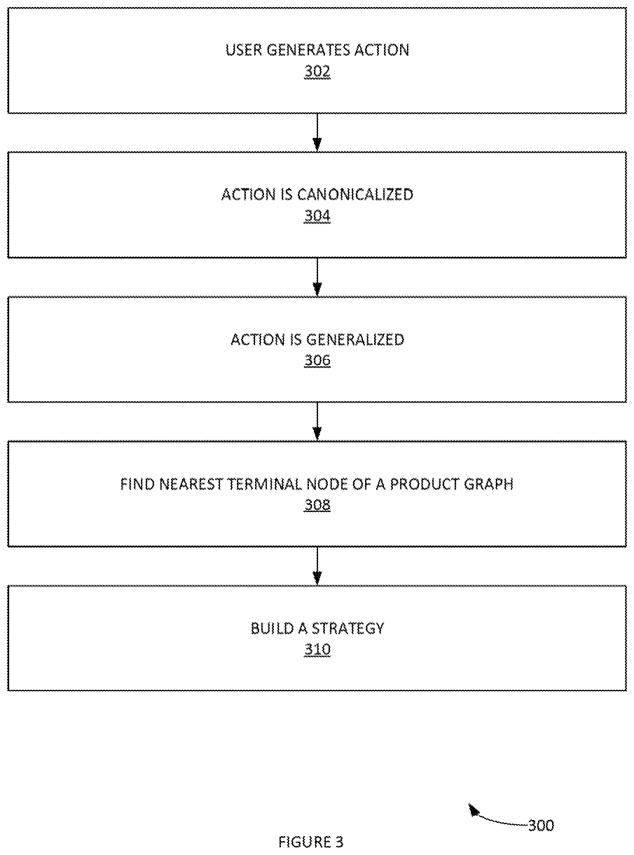

FIG. 3 depicts a flow diagram of yet another example process of a conversational-search engine, process 300, according to some embodiments. In step 302, a user generates an action (e.g. in fitness vertical “How bout with a born ankle?”). In step 304, an action can be canonicalized (e.g. “How about with a broken ankle?”). In step 305 the canonicalized action can be merged with the context of the conversation, if there is any prior context. The merge process can create a more detailed query. Existing conversation state can be represented as an encoded tensor, or a set of variables with particular values as a result of previous interactions. This tensor maps to a certain state (e.g. a hyper state) if the conversation has many states. The merge process can add the new processed input with this state to predict a new hybrid state. For example, if the prior context is about “best cycles to improve quad and calf muscles”, the merged query can be “What is the best therapy and workout cycles to improve quad muscles with a broken ankle?”.

In step 306, an action can be generalized (e.g. “find therapy for quad and broken ankle”). In step 307 the system query (e.g. generalized translated query) can be executed over the knowledge model. The knowledge model can return a decision/state or a pointer in the product graph. The pointer in the product graph provides the state of the conversation is ready to query about a product (e.g. the system knows that it should strategize a plan to fulfill variables for a therapy product for a broken ankle to strengthen quad muscles). In step 308, process 300 can find the nearest terminal node of a product graph. A terminal node in the product graph can be reached when all variables for a product are satisfied. For example, the therapy program for broken ankles can be reached once all the variables for this product are satisfied (e.g. for the therapy product to be fulfilled, the product graph can define age, gender, desired recovery period, profession, etc. as variables). Accordingly, the system can strategize a sequence of questions to acquire the variables one step at a time. At the same time the system can have multiple active plans to possible products/terminals. Step 308 can find the nearest terminal/product by measuring its distance from all viable terminals. The distance to a terminal is the number of unsatisfied variables to each particular product. For example, the therapy product for a broken ankle can have twelve (12) variables. Therefore, if none of these variables are already acquired, the distance to this terminal can be twelve (12). All the acquired variables from previous conversations and sessions can be stored in the context of the conversation. If in previous conversations the user had stated that he is an amateur soccer player, then the distance to the therapy product for broken ankle can be reduced to eleven (11) hops. The terminal node of a conversation graph can be a product/service to offer the user.

In step 310, process 300 can build a strategy to create a sequence of questions. The strategy can be designed to proactively guide a conversation towards a terminal (e.g. a product and/or service, etc.). Process 300 can do this proactively. For example, during a conversation at any moment the system can gauge its distance from offerings (e.g. products) in the product graph. For example, any financial services system can offer hundreds to thousands of products/services. Each product/service can have its own attributes/parameters. For example, a set of parameters (e.g. ten (10) different parameters) can be obtained from a sequence of user actions before a product is offered. Process 300 can have obtained a set of three (3) of them from the user. Accordingly, seven (7) additional hops, with each hop being an attribute/parameter, of the product/service, until the terminal node is reached. Each parameter is a hop/dependency in the graph. Users can cancel an already strategized plan by stating an action like “Stop it”, “I do not like to know about this therapy”. Alternatively, users can start asking about a different product at which point the old plan can be paused and a new plan can be strategized for a new goal. The new plan can fulfill the new goal (e.g. product, offering, terminal).

### Example Graphs

The following example models and graphs can be utilized by a conversational-search engine to implement processes 100-300.

FIG. 4 illustrates an example knowledge model 400, according to some embodiments. Knowledge model 400 can be heuristically admissible. Knowledge model 400 can comprise various states. A knowledge model is also a hyper graph or convolutional graph and the relationship between states can be represented as edges between nodes. Each node can represent a basic state/entity (e.g. in finance vertical basic entities can be 401k, IRA, Roth IRA, loans, bonds, distribution calculator, etc.). Also, nodes can be composite/hyper states/entities (e.g. in finance vertical composite entities can be “401k and IRA investment” 432). Each edge between the nodes can describe a particular relationship between the nodes. In finance a vertical these edges can be similarity, difference, compliance, to be part of, etc. Knowledge graph 400 can include a parent node 402. It is noted that in the present example, knowledge graph 400 can be for a set of retirement products. Accordingly, nodes 404-408 can represent retirement products, 432 is a composite node, “401k and IRA investments”. Node 446 is “Distribution calculator”, and node 444 is “changing job”. In other examples, knowledge graph 400 can include information for other domains (e.g. travel planning, education planning, etc.). Knowledge graph 400 can be automatically generated by an induction module and/or manually curated by an SME. Alternatively, a DMN can create a different induction model by processing actual and generalized conversation graphs. The knowledge graph and DMN induction model can function in parallel. Using a normalized probability model, the best output can be used.

Parent node 402 can indicate that the knowledge model (converted to a graph and represented as knowledge graph) 400 represents said retirement products. This relationship can be represented by edges 410-414. Edges 410-414 can define that nodes 404-408 are retirement products (e.g. 401k product 404, Roth IRA product 406, IRA product 408, etc.). Edges 416-420 can describe the similarities between the respective nodes that they are connecting. Edges 422-426 can describe the differences between the respective nodes that they are connecting. Edge 436-434 describes that the basic entity “401k” and the composite entity “401k & IRA investment” can use a distribution calculator. Edge 442 describes the best action between nodes “Changing job” and “401k & IRA investment”. In simple words, the edge 442 describes the best action a user can do if she/he has 401k and IRA accounts and is changing jobs. Edge 430 and 428 can describe that the nodes are part of each other (e.g. 401k is part of 401k and IRA investment funds). Each edge can contain plain text. For example, edge 416 can contain the text describing how 401k is similar to Roth IRA. Alternatively, edge 422 can described how 401k is different from Roth IRA. If user's generation action is “tell me, how is 401 diffrnt from Roth IRA?” (not that misspelled words can be automatically auto corrected), this action is canonicalized to “How is 401k different from Roth IRA?” and then translated to “find difference for 401k and Roth IRA”. This query can find edge 416. The plain text in this edge can be returned as the decision. This plain text can be later contextualized and personalized to look more colloquial. The colloquial text can be penalized, rewarded, or altered by an SME so the system can actively learn from it using reinforcement learning techniques. The final text can be returned to the user as the decision made by the system in response to her/his action. If the user's action is “How much money can I spend 10 years after I retired if I am contributing to an IRA and 401k?”, the system can generalize this query to “find distribution calculator for IRA and 401k?” (ten (10) years after retirement can be saved in the context of the conversation as a fulfilled variable). This system query can return edge 434. This edge can contain a pointer to a product in the product graph instead of plain text only. The pointer to the product graph can help the system to strategize a plan to ask a sequence of questions to guide the conversation to fulfill the goal of finding annual distribution for 401k and IRA investments. Edges can contain plain text and/or pointers to one or multiple products in the product graph. In case multiple products are returned, the system can strategize a plan for the nearest terminal/product/offering/goal.

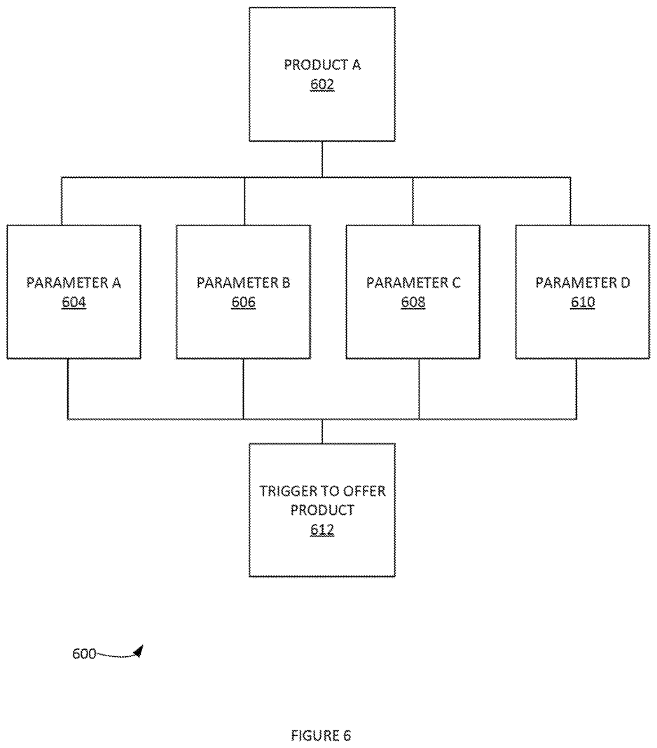

FIG. 5 illustrates an example conversation graph 500, according to some embodiments. There are two conversation graphs: an actual conversation graph and a generalized conversation graph. The actual conversation graph can contain the actions generated by all users and the final generated decisions by the system. The actual conversation graph can be used as an input to a DMN to create an induction network. Each node in the actual conversation graph represents an actual action generated by a user (e.g. “I need to drop 15 lbs. in 1 week”), or a final decision generated by the system (e.g. “That a bit aggressive, what is your weight?”) or it can be a product (e.g. “The order for this diet is placed, an email is sent to your inbox”). The generalized graph contains generalized actions and the raw decisions made by the system. If a decision is penalized or altered by a SME, the correct version of that decision can be stored in the generalized conversation graph. The nodes in the generalized conversation graph can be generalized actions (e.g. “find 401k distribution calculator”), or a decision made by the system (e.g. “What is $USERS age?”), or it can be a product/offering/goal/terminal (e.g. “The appointment email is sent”). The number of overlapping nodes in a generalized graph can be much higher than the number of overlapping nodes in the actual conversation graph. Conversation graph 500 can illustrate a history of different prior conversations over a period of time (e.g. for a plurality of users). A conversational-search engine can utilize these conversations to learn from. Conversational search and planning engine can use the generalized and actual conversation graph for search and planning. As the conversation graph aggregates more and more conversations the function of goal prediction of a conversation based on its early interactions can become more accurate. Conversation graph 500 can be a log of past actions and/or responses. Conversational-search engine can review the historical log and determine a similarity with later conversations. In this way, conversational-search engine can leverage this historical information in determining a more-informed current response to a user action.

Conversation graph 500 can initiate with a greeting 502. Greeting 502 can be implemented in a natural-language format. Greeting 502 can be colloquial. Greeting 502 can be personalized for the user.

Conversation graph 500 can include a series of states/nodes that terminate with a product offer. The series of nodes can alternate between user actions 504, 508, 510, 512, 516, 518 (e.g. a user node) and conversational-search engine responses 506, 514, 520 (e.g. a system node). An action can be a user input such as a question related to the relevant domain. A response can be an answer, a query to the user for more information, etc. It is noted that, in some example embodiments, a product offer can include an offer for a service and/or various advice/information. Conversation graph 500 can be used to implement goal-based planning for a specific domain. The conversational search and planning engine can use sequence 2 sequence deep learning techniques to translate low level system decisions, returned as a result of system queries over knowledge graph, to colloquial, personalized, and contextualized decisions/answers/responses. This can happen in parallel to other machine learning and artificial intelligence techniques. The system generated decisions/responses/answers can be inspected by SMEs. SMEs can reward, penalize and/or alter system generated content. Such penalties, rewards, and changes can be fed back to future learning iterations. The conversational search and planning engine can use reinforcement learning techniques along with other machine learning and artificial intelligence techniques to learn from SME feedback.

As shown in FIG. 5, conversations can have overlapping states/nodes. For example, two conversations can share common user actions and/or conversational-search engine responses. For example, since conversations are represented as states, it is common for two conversations to share sub states. The conversational search and planning engine can use a generative adversarial network to convert system level responses to colloquial, contextualized, and personalized sentences.

Conversation graph 500 can draw its response from a knowledge model (e.g. knowledge model 400, etc.). It is noted that conversational-search engine can answer questions (e.g. not related to a product graph). Once one or more user actions are received, a conversational-search engine can generate a plan towards a nearest product node. Conversational search and planning engine can use machine learning and artificial intelligence techniques (e.g. deep learning sequence 2 sequence) to convert and/or summarize and/or generalize user generated actions to system level queries. The system level queries can be queried over a knowledge graph. For example, this user action “My college interest rate is awful, it is frustrating.” can be translated to “find solution for high interest rate for college loan”. A neural network can be applied to the user input to generate a system query. The system query can be applied over an applicable knowledge model. The knowledge model can return a raw system-level answer which is not yet ready to be dispatched to users. The conversational search and planning engine can use machine learning and artificial intelligence techniques to translate raw system level text to contextualized, personalized and colloquial format.

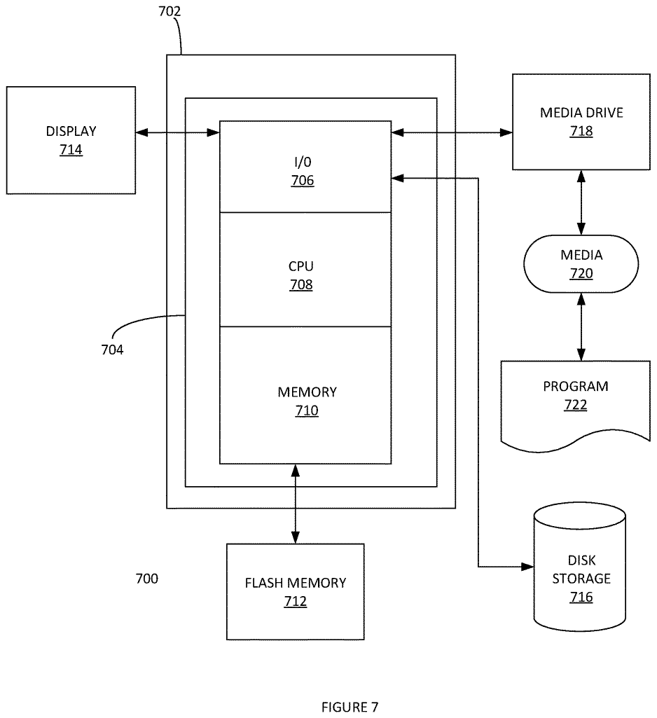

FIG. 6 illustrates an example product graph 600, according to some embodiments. Product graph 600 can provide and explain parameters/attributes that are to be satisfied for a product to be offered. For example, in the financial services vertical, a 401k distribution calculator service (e.g. product) can have the following parameters/attributes: current age, preferred age of retirement, current 401k saving, annual salary and few other parameters. Product A 602 can be the 401k calculator and parameter 604 to 610 can be its parameters/attributes. Once these parameters are acquired by the conversational search and planning engine via a sequence of interactions, then the system can conclude that the terminal for product 602, in this case 401k calculator, is reached and this product can be offered. In this case the calculation can start, and the projections can be displayed to the user. Product graph 600 includes domain specific products but can be adapted to any applicable domain. For example, in the fitness vertical, a half marathon training program can be a product and it can have the following parameters: age, gender, race date, current best record, etc.

Product graph 600 can include one or a plurality of products. Product 602 can have product parameters 604-610. When parameters 604-610 are detected in a series of user and system interactions, conversational-search and planning engine can offer the fulfilled product offering 612 to the user. Node 612 is the terminal/trigger/goal in the product graph. In the financial services vertical, for the 401k calculator example, this node is reached when all parameters necessary for calculating 401k projections are collected and fulfilled. Once node 612 is reached the system can offer the 401k calculator, in which case, it can start calculating the 401k projections. The conversational search and planning engine strategizes plans based on parameters associated to products in the product graph. A plan is a series of decisions designed to guide the conversation to a direction, so the system can collect the parameters associated with a product in the product graph. The goal-based planning can be done by a plurality of planning techniques including but not limited to finding a product with most satisfied parameters, or a variations of extended Partially Observable Markov Decision Process, or Bayesian Inferencing, or shortest path by A*, or beam search or a hybrid of such methods. Products that have the least number of unfulfilled parameters can be closer to their corresponding terminals. The conversation graph can implement planning based on the product graph.

### ADDITIONAL EMBODIMENTS AND EXAMPLES

In some embodiments, two types of sequence-to-sequence neural networks can be utilized by a conversational-search engine. A first sequence-to-sequence neural network can generalize actions generated by users. A specific sequence of words from the user action can be translated to a planner query language. For example, “401k vs. IRA” can be translated to “compare 401k to IRA”.

Conversational-search engine can use a word-embedding technique. Word embedding can be a multidimensional representation of vocabulary (e.g. continuous bag of words, glove, etc.).

Conversational-search engine can use generative methods to translate a colloquial query language to a system level query language. In one example of utilizing a neural network, the conversational-search engine can provide output to a second neural network to generate a colloquial answer. For example, conversational-search engine can output “401k is pretax, and IRA is post tax”. Accordingly, there can be a sequence that the conversational-search engine would like to translate to a colloquial format. The conversational-search engine can have a set of personal attributes of the user. These personal attributes can be used to personalize the colloquial output. The conversational-search engine can translate the colloquial output to personalized text: “in your case 401k is pretax and IRA is after tax”. The conversational-search engine can action/state translated into a personalized-colloquial answer for the user. Another technique in tandem with this can be an adversarial generated network to further check if the output answer is ‘good enough’ to be dispatched. For example, the conversational-search engine can be paired with a human SME to check output and provide feedback that is fed into a reinforcement learning system. The SME can reward good answers and penalize bad answers.

In one example, a user can generate an action. The conversational-search engine can then seek to return a decision. A decision is generated by the conversational-search engine and can be altered by human subject matter experts. The action can be canonicalized (e.g. spell checking, clean Up text, etc.) and generalized by a neural network. The action can also be generalized. The generalized action is queried over a knowledge graph. The decision can be input into a generator neural network. The generator decision can be rewarded/penalized and/or altered by SME. The final decision is sent to the user (e.g. rendered for display on a computer display device, audio output, etc.).

In one example, conversational-search engine can proactively plan a strategy to reach a product terminal node in a conversation graph. The conversational-search engine can determine the nearest terminal node (e.g. a product node). Distance can be quantified as a number of hops to each terminal node in the product graph. For example, in the financial services vertical, college loan rate calculators can have multiple parameters like current interest rate, remaining amount, credit score, etc. If any of such parameters are already acquired and fulfilled, then the distance to the terminal node for this product can be reduced by the number of already collected parameters. Additionally, it can be determined if the terminal node is viable (e.g. is a probability based on what acquired thus far based on number of steps away). If ‘yes’, then conversational-search engine can begin querying the user regarding the product parameters If a terminal node is too far away (e.g. greater than a specified number of hops) then conversational-search engine can wait a certain number of interactions with the user before start building a strategy. For example, the conversational-search engine can continue in a reactive mode (e.g. simple question and answering).

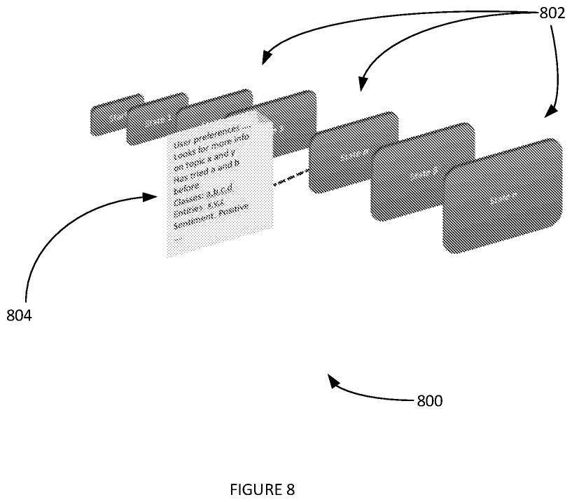

FIG. 8 illustrates an example schematic depiction of a conversation 800 as a sequence of states 802, according to some embodiments. As shown by way of example in FIG. 8, a conversation can be modeled as a sequence of states 802 (e.g. starting from state 0 and proceeding to state n). Once an input or query is generated by a user, the system can react to it. Accordingly, the system moves the conversation to a new state. The state has many variables 804 associated to it, including, inter alia: classes, entities, sentiment, translation, canonicalized parts/chunks, history, and projected future(s).

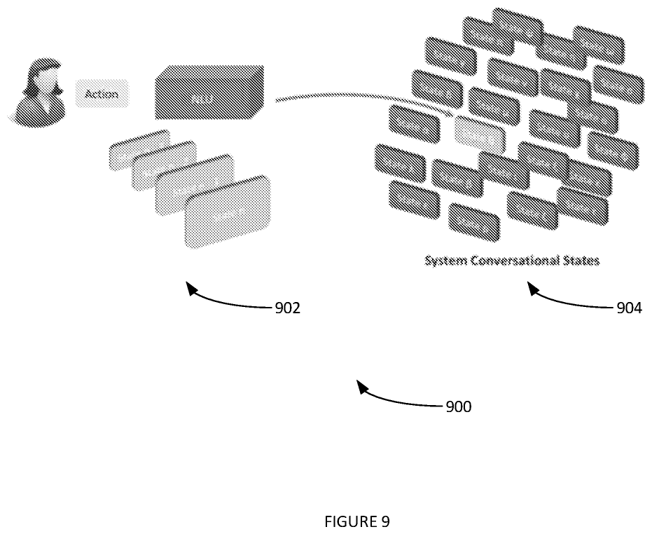

FIG. 9 illustrates an example implementation of an NLU system 900, according to some embodiments. As depicted in the FIG. 9, NLU is responsible to draw patterns, entities, classes, canonicalized and summarized parts, to a state to which the system can react. The system uses processed input in conjunction with the preceding states to better map the processed input to a future state. On the left-hand side a sequence of conversation states, starting with greeting or state zero and continuing to state n, being the current/latest state of the conversation prior to processing of the incoming action from the user. The aggregated conversation state(s) (e.g. context) 902, plus the understood and processed action, can be mapped to an equal/similar state within the space model 904:

(context+*processed_action=*state in space model)+* and =* are VSM plus and equality

It is noted that this translation and querying of the space model adds an additional layer of security and clarity to the NLU system 900. For example, the NLU system 900 draws patterns from the aggregated conversation state(s) 902 of the left-hand side of FIG. 9 plus the latest received action from the user and determines an equivalent for this new tensor in space model 904 of the right-hand side. The space model 904 can be pre-processed and curated. In one example, the space model 904 can be known, the aggregated conversation state(s) 902 can be deduced. This mapping reduces the inherent vagueness of the AI blackbox and adds more light to what the system is actually undertaking.

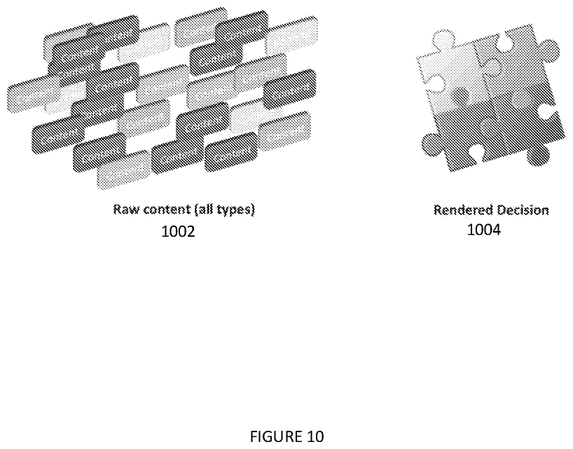

FIG. 10 illustrates an example schematic diagram illustrating an example target state/decision 1000, according to some embodiments. As depicted, the target state/decision 1000 can be rendered using multiple pieces of raw content.

### Exemplary Environment and Architecture

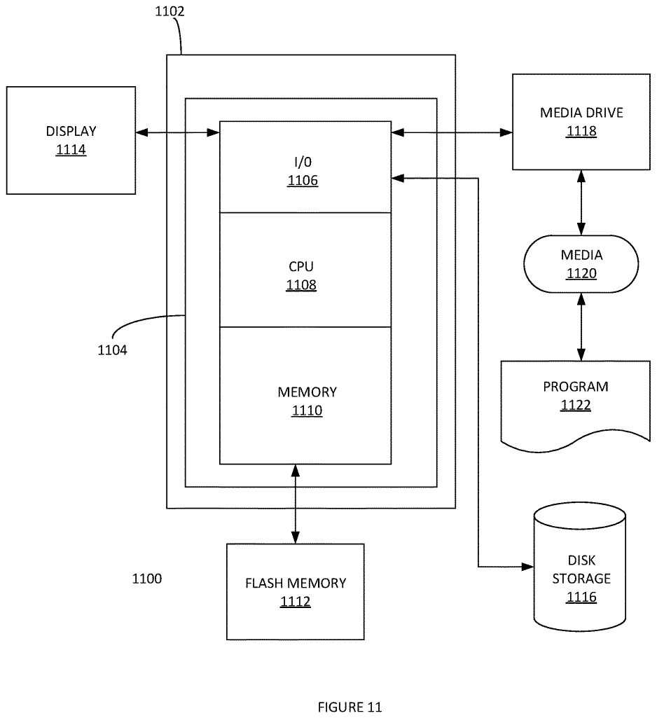

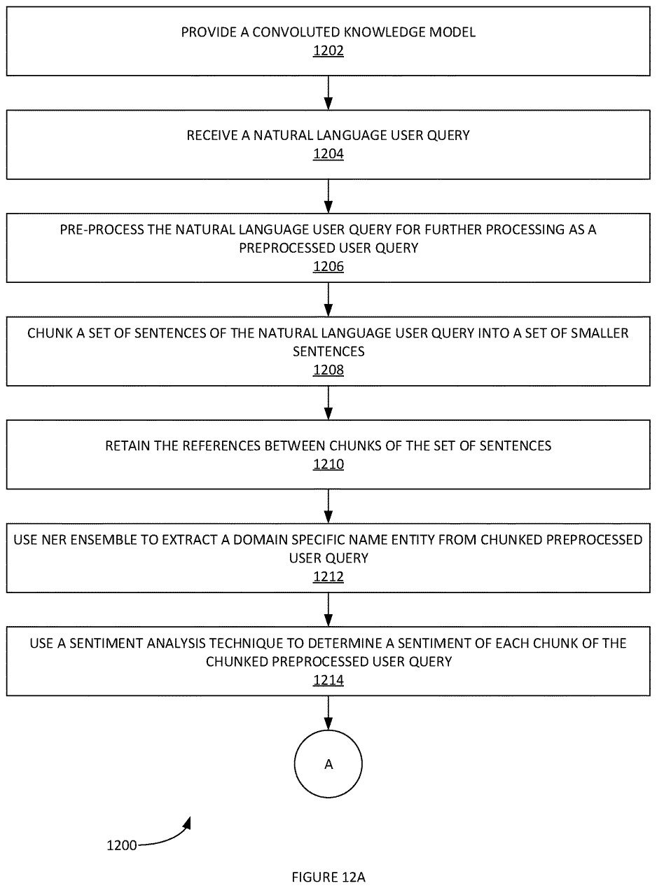

FIG. 11 depicts an exemplary computing system 1100 that can be configured to perform any one of the processes provided herein. In this context, computing system 1100 may include, for example, a processor, memory, storage, and I/O devices (e.g., monitor, keyboard, disk drive, Internet connection, etc.). However, computing system 1100 may include circuitry or other specialized hardware for carrying out some or all aspects of the processes. In some operational settings, computing system 1100 may be configured as a system that includes one or more units, each of which is configured to carry out some aspects of the processes either in software, hardware, or some combination thereof.

FIG. 11 depicts computing system 1100 with a number of components that may be used to perform any of the processes described herein. The main system 1102 includes a motherboard 1104 having an I/O section 1106, one or more central processing units (CPU) 1108, and a memory section 1110, which may have a flash memory card 1112 related to it. The I/O section 1106 can be connected to a display 1114, a keyboard and/or other user input (not shown), a disk storage unit 1116, and a media drive unit 1118. The media drive unit 1118 can read/write a computer-readable medium 1120, which can contain programs 1122 and/or data. Computing system 1100 can include a web browser. Moreover, it is noted that computing system 1100 can be configured to include additional systems in order to fulfill various functionalities. Computing system 1100 can communicate with other computing devices based on various computer communication protocols such a Wi-Fi, Bluetooth© (and/or other standards for exchanging data over short distances includes those using short-wavelength radio transmissions), USB, Ethernet, cellular, an ultrasonic local area communication protocol, etc.

### Additional Example Processes

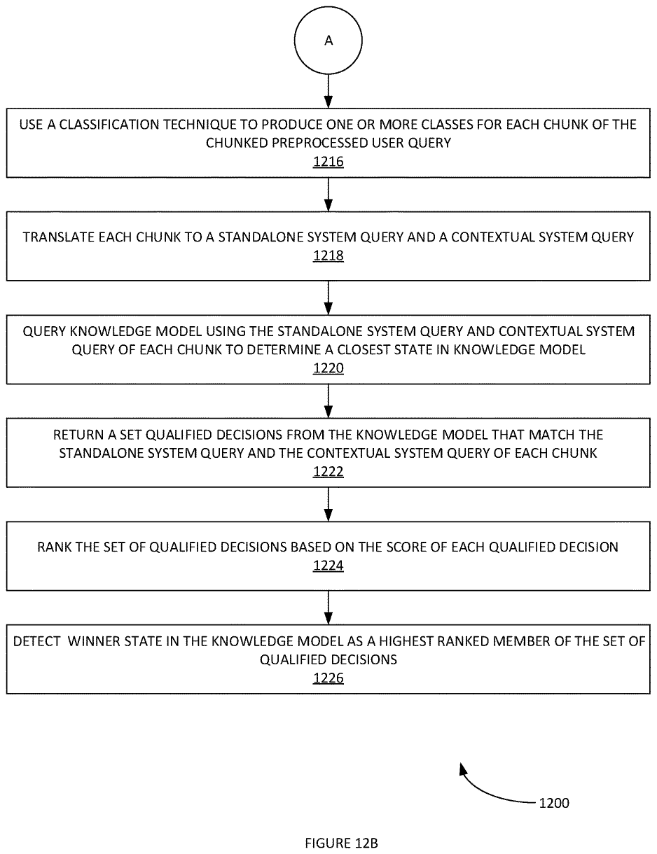

FIGS. 12 A-B illustrates an example process 1200 useful for, with an ensemble of Natural Language Understanding and Processing methods, converting a set of user actions into one or more machine queries over a convoluted data model, according to some embodiments. In step 1202, process 1200 can provide a convoluted knowledge model. In step 1204, process 1200 can receive a natural language user query.

In step 1206, process 1200 can preprocess the natural language user query for further processing as a preprocessed user query. The preprocessing can include various steps as follows. In step 1208, process 1200 can chunk a set of sentences of the natural language user query into a set of smaller sentences. In step 1210, process 1200 can retain the references between chunks of the set of sentences.

With the preprocessed user query, for each chunk of the chunked preprocessed user query process 1200 can perform the following steps. In step 1212, process 1200 can use a Name Entity Recognition (NER) ensemble to extract a domain specific name entity from the chunked preprocessed user query. In step 1214, process 1200 can use a sentiment analysis technique to determine a sentiment of each chunk of the chunked preprocessed user query. In step 1216, process 1200 can use a classification technique to produce one or more classes for each chunk of the chunked preprocessed user query.

For each chunk, process 1200 can perform the following steps. In step 1218, process 1200 can translate each chunk to a standalone system query and a contextual system query. In step 1220, process 1200 can query the knowledge model using the standalone system query and the contextual system query of each chunk to determine a closest state in the knowledge model. In step 1222, process 1200 can return a set of qualified decisions from the knowledge model that match the standalone system query and the contextual system query of each chunk. Each qualified decision is scored. In step 1224, process 1200 can rank the set of qualified decisions based on the score of each qualified decision. In step 1226, process 1200 can detect a winner state in the knowledge model as a highest ranked member of the set of qualified decisions.

### Owner-Aware, Scalable Customized and Personalized Coaching in Deep Contextual Natural Conversations

The system, apparatus and methods described here is designed to augment tutors, coaches, mentors, and SMEs to produce factually and legally accurate responses to their audience, consumers, and students at scale.

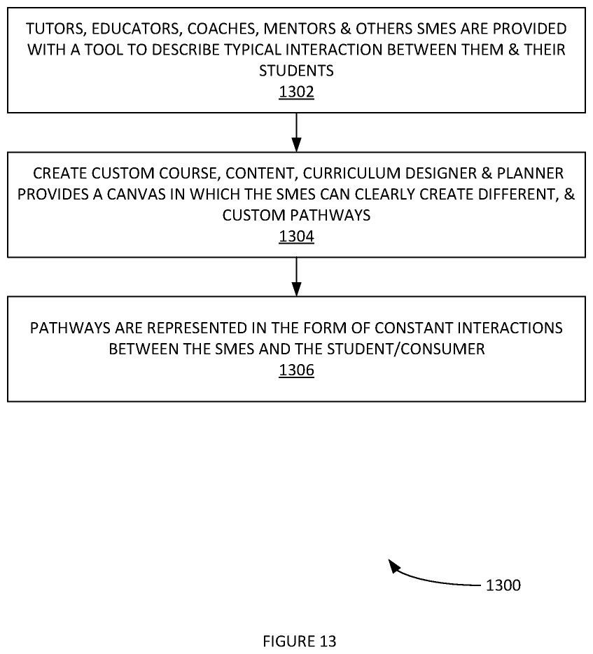

FIG. 13 illustrates an example process 1300 for augmenting Subject Matter Expert (SME) interactions, according to some embodiments. An artifact can be provided. In this artifact an augmentation apparatus is detailed which its design is aimed at augmenting the SME (e.g. a coach, a mentor, a tutor, educators, and other SMEs, etc.). An SME can provide personalized advice, in order to deliver individualized, and customized advice to consumers, mentees, and students.

In step 1302, tutors, educators, coaches, mentors, and other SMEs are provided with a tool to describe typical interaction between them and their students. This can be implemented, one scenario at a time, during which personalized advice is delivered to each student. By the end of such interactions each student, or consumers is expected to have learned a skill, technique, a solution to a problem, or answer to a custom and contextual question.

In step 1304, the tool is used to create custom course, content, curriculum designer and planner provides a canvas in which the SMEs can clearly create different, and custom pathways (e.g. see infra).

Each pathway guides a student from point zero to a mastery point. These pathways can overlap with one another. In step 1306, pathways are represented in the form of constant interactions between the SMEs and the student/consumer.

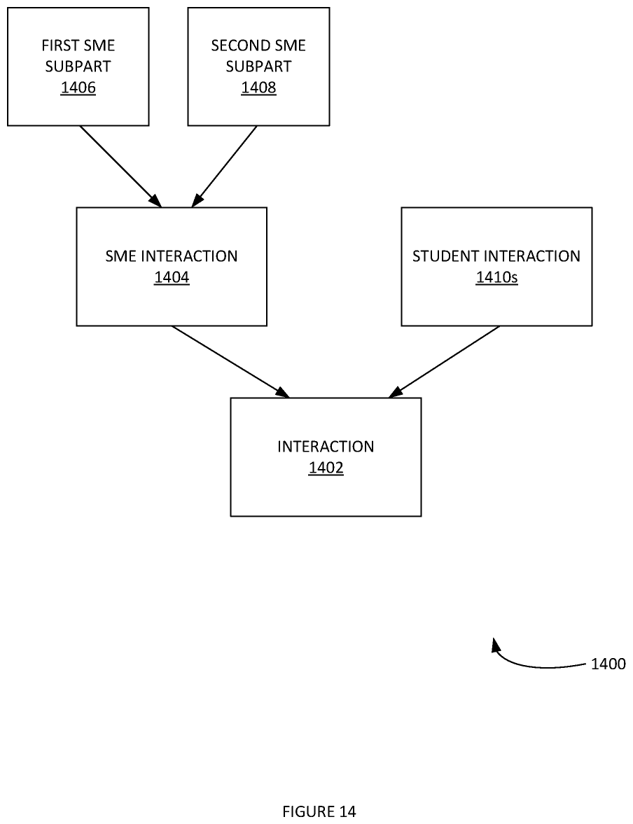

FIG. 14 illustrates an example interaction schema 1400 for implementing a transaction in an SME interaction, according to some embodiments.

It is noted that an interaction 1402 has two parts. An SME part 1404 produced by the SMEs. SME part 1404, itself, has two subparts: first SME subpart 1402 and second SME subpart 1404. First SME subpart 1406 is configured to answer to a prior inquiry or continue a prior sequence. Second subpart 1408 is configured to assess the consumer/student and/or acquire their readiness to continue and/or to seek if their understanding of the provided custom content and personalized advice is accurate. This can occur via one or series of assessments. The design mandates the SME to end his/her part of the interaction with an inquiry to force the student/consumer to produce a reaction.

The student part 1410 of the interaction is produced by the student. The student is expected to produce a relevant response to the question or assessment raised by the SME. Based on the accuracy or state of the response given by the student, the subsequent interaction can be determined. In addition to contextually relevant responses, the student can produce a statement, or query which is not contextually relevant to the immediate question, assessment or inquiry raised by the SME. In such a case the next interaction will have to address the action produced by the student.

In some embodiments, a pathway can be modeled as a series of interactions, starting with an entry point, and ending with a terminal by which the consumer or student is expected to have been assessed to have achieved mastery about the subject taught through the custom pathway.

The SME part 1404 and the student part 1410 of each interaction is designed to be around thirty (30) seconds or less, and no longer than sixty (60) seconds. The duration has to be around one hundred and twenty-five (125) words or less, and no more than two hundred and fifty (250) words. If the format of the response is not text, the produced video, audio, or stream type of any type has to be around thirty (30) seconds or less, no more than sixty (60) seconds long. The SME part 1404 of the interaction is produced by the SME, Coach, Mentor, Educator, Teacher or Tutor. The student part 1410 of the interaction is produced by the student.

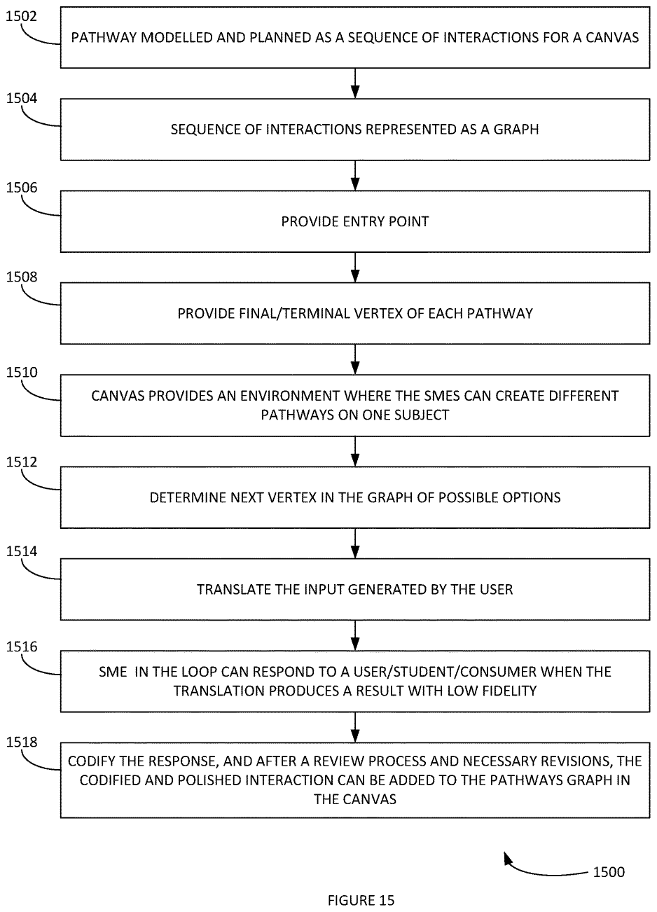

FIG. 15 illustrates an example process 1500 for custom course/content designing, according to some embodiments. In step 1502, a pathway is modeled and planned as a sequence of interactions for a Canvas (e.g. the custom course, content, curriculum designer and planner canvas (for short referred to as Canvas herein), etc.). The sequence of interactions can be represented as a graph in step 1504. The entry point (e.g. a source vertex of each pathway resembles the contextual baseline, prior contextual knowledge, background, and understanding of the consumer/user/student from the subject, which is coached and taught during the pathway, etc.) is provided in step 1506. In step 1508, the final/terminal vertex of each pathway is provided as an interaction at which the consumer/user/student can have achieved mastery on the subject being taught and coached throughout the pathway.

The Canvas provides an environment where the SMEs can create different pathways on one subject in step 1510. Each custom pathway can be an individualized path for a student given a particular understanding of the subject at hand and ending with a terminal interaction by reaching which that student is verified to have achieved mastery at the given subject, through navigating their personal and custom path.

All the pathways on a given subject can have overlapping interactions. For example, if the subject to be taught is Conditionals in ESL, there can be multiple entry points to the graph of existing pathways. For example, one student might need a review in future tense before reviewing the conditionals. Another student may already know about conditional type zero and can skip that part. In this example, thirty percent (30%) of the students have to go through conditional type one. The interactions covering the conditional type one can be among the shared vertices in the graph of different pathways.

After acquiring a student's action in every interaction, the next vertex in the graph of possible options can be determined in step 1512. After acquiring a student's action in every interaction, process 1500 translates the input generated by the user, which can be of any type including by not limited to audio, video, text, or AR or VR gestures, into already recognized states in step 1514. If the translation and mapping to a known state does not happen with a desired fidelity, then a SME in the loop can review the interaction and respond to the inquiry generated by the user/consumer/student.

In step 1516, the SME in the loop can respond to a user/student/consumer when the translation produces a result with low fidelity. Once this live response is captured by process 1500 can codify the response, and after a review process and necessary revisions, the codified and polished interaction can be added to the pathways graph in the canvas in step 1518.

When a topic is taught and coached enough times to multiple students with different backgrounds and needs, enough unseen interactions and states are captured and added to the pathways graph on that subject. This continuous detection and addition of unseen states continuously enriches the pathways graph in the canvas. Once a subject pathways graph is enriched enough it can be with limited dependence on an SME in the loop.

When a subject pathways graph is rich enough, the SMEs in the loop will not be obligated to be constantly engaged. At this point multiple students can be monitored and handled by one SME in the loop. At all times students are coached and guided through their custom and individual pathways towards mastery for the given subject at hand, regardless of mode of coaching. The high-fidelity responses produced by the system (e.g. SME interaction system 1700 discussed infra) are fetched by the system from existing codified interactions in the canvas, or when necessary, by a human SME in the loop.

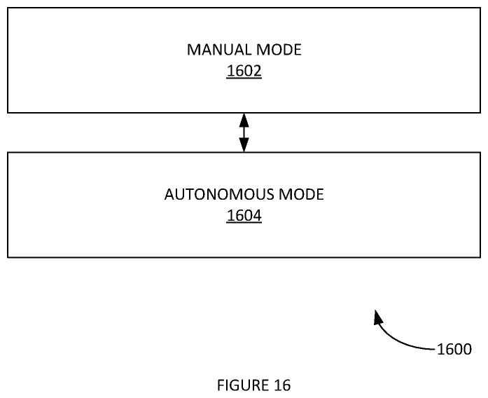

FIG. 16 illustrates an example process 1600 teaching/coach in two modes, according to some embodiments. The two modes can be a manual mode 1602 and autonomous mode 1604. Manual coaching and teaching happens when a human SME produces a response. Autonomous coaching and teaching happens when the system fetches a high-fidelity response from existing states in the pathways graph for a particular subject.

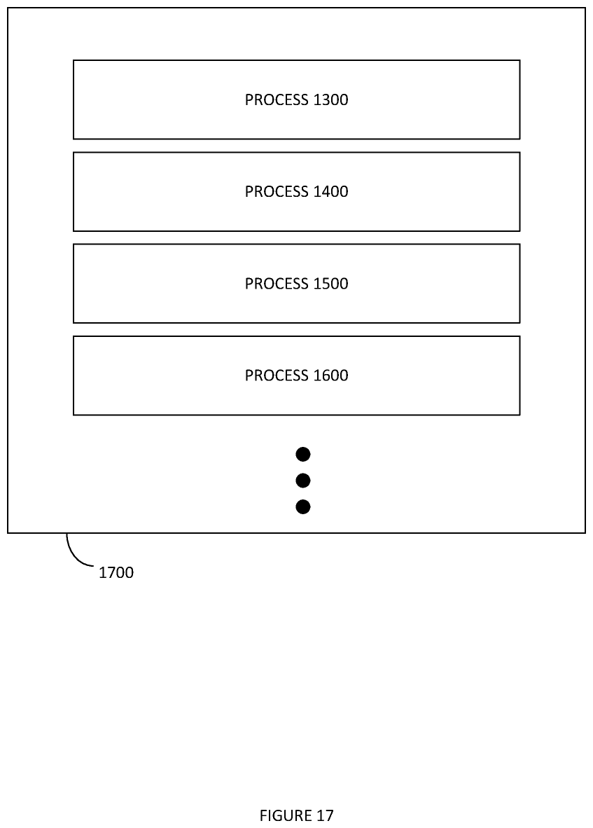

FIG. 17 illustrates an example Subject Matter Expert (SME) interaction system 1700, according to some embodiments. Processes 1300-1600 can be implemented by a SME interaction system 1700. Each codified state and interaction in SME interaction system 1700 has a known producer. In other words, SME interaction system 1700 can trace back the owner and creator of each codified training data. An atomic state or interaction part has a known owner. The owners can be SMEs, consumers, or no owner since the state belongs to the public domain.

A custom pathway can have one to many atomic and composite states. Each atomic state has at least one owner. Each composite state can have one or more owners. A custom pathway can have one or multiple owners.

A custom pathway is a composition of one or multiple interactions (e.g. states). Each state can be of type atomic or composite (e.g. see supra, etc.). Each atomic or composite state can have one or more training data or content owners.

A pathway can be composed by states and interactions produced by one or more SMEs (e.g. coaches, mentors, tutors, educators, teachers, etc.). As a consumer/user/student is being taught by SME interaction system 1700, regardless of the coaching mode, whether manually or autonomously, SME interaction system 1700 can produce detailed analytics to show list of content, course, and curriculum creators whose content and data have been used to help that student achieve mastery by navigating through their personalized pathway.

SME interaction system 1700 can trace back each codified state to one or more owners using different techniques including but not limited to hashing and NFTs. SME interaction system 1700 can trace whose content is being taught autonomously, therefore it can calculate the passive income generated for that content owner.

The owner-aware model keeps recognizing the content creators content when they are shared in another custom pathway created by another content planner and creator. The owner-aware model can reward the content creator by a point system when their content is confirmed to have been used in a custom pathway interaction created by them or some other content creator or planner.

A student can be coached, mentored, guided, and taught, by at least one or multiple SMEs. Each student can be guided through their custom and individualized pathway to achieve mastery on the subject they have chosen to study. Each custom pathway can have one or multiple interactions (e.g. states). Each state can have one or multiple owners. Therefore, each student can be coached and taught in a personalized manner by one or multiple content owners.

SME interaction system 1700 can map, translate, and convert the codified states into other media types. For example, a text response or content can be converted to video format. The auto generated video can depict an avatar of the SME or replace them with a branded avatar and or a branded voice actor, in a branded environment if the media format is VR or AR. The training data used to auto generate content in any target media type using a codified input state, can be traced back to one or multiple owners. The personalized learning experience rendered by SME interaction system 1700 can have one or multiple SMEs, zero or multiple branded or public domain actors, zero or multiple branded or public domain virtual items, environments, spaces, and virtual places.

The personalized learning experience rendered by the system can have one or multiple SMEs, zero or multiple branded or public domain actors, zero or multiple branded or public domain virtual items, environments, spaces, and virtual places.

Appendix A includes screenshots illustrating example embodiments and various information that can be utilized by the systems and methods discussed supra. It is noted that the interactive scalable customize-able pathways is fundamentally different from other content in that this model has n-degree of freedom and the other content. In this model you can go into n different directions.

Every action uttered or generated by users (aka consumers, students or mentees) will be codified to state in the system. Every reaction generated by the autonomous coach, or the agent in the loop is also codified to a state in the system. These states can be atomic or composite (aka. hybrid). The actions and decisions (aka. responses, or reactions generated by an agent in the loop or an autonomous coach) can be codified as is or processed and then codified. A codified state can map to multiple natural language sentences or sequences of coherent, sensible, factually correct and if necessary legally sound, and meaningful words.

### CONCLUSION

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python) and/or some specialized application-specific language (PHP, JavaScript, XML, JSON). It is noted that JavaScript has been used as an example in several embodiments. However, in other embodiments, another scripting language and/or JavaScript variant can be utilized as well.

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computer-implemented method of providing scalable personalized coaching, comprising: receiving, by a computing system, a plurality of subject matter expert (SME) interactions, wherein each SME interaction comprises an SME response portion and an expected student response portion; generating, by the computing system, a plurality of custom learning pathways based on the SME interactions, wherein each custom learning pathway comprises a sequence of interactions leading from an entry point to a terminal mastery point; receiving a student input; determining, by the computing system, a current state based on the student input; identifying an applicable learning pathway from the plurality of custom learning pathways based on the current state; generating a personalized response based on the applicable learning pathway; tracking ownership attribution for content used in the personalized response; and storing the ownership attribution in association with usage metrics of the content.

2. The method of claim 1, wherein each SME interaction is limited to a maximum duration of sixty seconds or a maximum of two hundred and fifty words.

3. The method of claim 1, wherein generating the plurality of custom learning pathways comprises: representing the SME interactions as nodes in a pathway graph; and identifying overlapping nodes shared between different learning pathways.

4. The method of claim 1, further comprising: determining a fidelity score for the translation of the student input to the current state; and routing the student input to a live SME when the fidelity score is below a threshold.

5. The method of claim 4, further comprising: capturing the live SME's response; codifying the response into a new interaction; and adding the new interaction to at least one custom learning pathway.

6. The method of claim 1, wherein tracking ownership attribution comprises: generating a unique identifier for each piece of content contributed by an SME; and maintaining a record of content usage across multiple learning pathways.

7. The method of claim 1, further comprising: converting the personalized response from a first media type to a second media type while maintaining the ownership attribution.

8. The method of claim 1, wherein generating the personalized response comprises: selecting content elements from multiple SMEs; and tracking proportional ownership attribution for each SME's content elements.

9. The method of claim 1, further comprising: calculating compensation for content owners based on the usage metrics and ownership attribution.

10. The method of claim 1, wherein generating the personalized response comprises: analyzing the student input for contextual relevance to a previous interaction; selecting a next interaction from the applicable learning pathway when the student input is contextually relevant; and initiating a new pathway when the student input is not contextually relevant.

11. The method of claim 1, wherein the terminal mastery point represents verification that a student has achieved mastery of a subject through completion of the custom learning pathway.
